(19) United States
(12) Patent Application Publication
(10) Pub. No.: US 2025/0274980 A1
(43) Pub. Date: Aug. 28, 2025

(54) FAST PARAMETER ADAPTATION FOR WIRELESS NETWORKS

(71) Applicant: Samsung Electronics Co., Ltd., Suwon-si (KR)

(72) Inventors: Peshal Nayak, Plano, TX (US); Bilal Sadiq, Plano, TX (US); Boon Loong Ng, Plano, TX (US); Rubayet Shafin, Allen, TX (US); Vishnu Vardhan Ratnam, Frisco, TX (US); Yue Qi, Plano, TX (US)

(21) Appl. No.: 19/061,877

(22) Filed: Feb. 24, 2025

Related U.S. Application Data
(60) Provisional application No. 63/557,861, filed on Feb. 26, 2024.

(51) Int. Cl. H04W 74/0816; H04W 84/12

(52) U.S. Cl. CPC H04W 74/0816; H04W 84/12

(57) ABSTRACT

An embodiment includes a transmitter and a receiver may negotiate a feedback procedure for the purpose of transmission parameter adaptation, whereby the receiver can provide periodic or unsolicited feedback to the transmitter to assist the transmitter with parameter adaptation and the transmitter can transmit data to the receiver using the adapted parameters that have been adapted based on the feedback received from the receiver.

### CROSS-REFERENCE TO RELATED APPLICATIONS

This application claims the benefit of priority from U.S. Provisional Application No. 63/557,861, entitled “FAST PARAMETER ADAPTATION PROCEDURES FOR NEXT GENERATION WLANS” filed Feb. 26, 2024, which is incorporated herein by reference in its entirety.

### TECHNICAL FIELD

This disclosure relates generally to a wireless communication system, and more particularly to, for example, but not limited to, fast parameter adaptation for wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure a first device associated in a wireless network, the first device comprising a memory; and a processor coupled to the memory. The processor is configured to transmit, to a second device, a first frame using at least one transmission parameter at a first configuration. The processor is configured to receive, from the second device, a feedback frame that includes feedback information related to one or more transmission parameters. The processor is configured to reconfigure if needed the at least one transmission parameter to a second configuration based on the feedback frame.

In some embodiments, the first device is a non-access point (AP) station (STA) or an AP STA.

In some embodiments, the processor is further configured to transmit, to the second device, a third frame indicating that the first device is capable of reconfiguring one or more transmission parameters.

In some embodiments, the processor is further configured to receive, from the second device, a feedback frame on a periodic basis that include feedback information related to the one or more transmission parameters.

In some embodiments, the processor is further configured to transmit, to the second device, a control frame that solicits the feedback information, wherein the feedback frame is received in response to the control frame.

In some embodiments, the first frame and the second frame are transmitted in a same transmission opportunity (TXOP) and the feedback frame is received between the first frame and the second frame.

In some embodiments, the feedback frame is a block acknowledgement (BA) variant frame.

In some embodiments, the processor is further configured to transmit an initial control frame to the second device to negotiate to receive feedback information; and receive from the second device, a response frame to the initial control frame that includes an indication that the second device will provide the feedback information.

In some embodiments, the first frame is transmitted on a plurality of channels to check which channels do not suffer from interference, wherein the feedback frame is received on a subset of the plurality of channels that are suitable for transmission.

In some embodiments, the at least one transmission parameter includes at least one of a transmit power, a transmission rate, a bandwidth, a number of spatial streams, or unavailability related information.

One aspect of the present disclosure provides a first device associated in a wireless network, the first device comprising: a memory; and a processor coupled to the memory. The processor is configured to receive, from a second device, a first frame that is transmitted with at least one transmission parameter at a first configuration. The processor is configured to transmit, to the second device, a feedback frame that includes feedback information related to one or more transmission parameters. The processor is configured to receive, from the second device, a second frame that is transmitted with the at least one transmission parameter at a second configuration.

In some embodiments, the first device is a non-access point (AP) station (STA) or an AP STA.

In some embodiments, the processor is further configured to receive, from the second device, a third frame indicating that the second device is capable of reconfiguring one or more transmission parameters.

In some embodiments, the processor is further configured to transmit, to the second device, a feedback frame on a periodic basis that include feedback information related to the one or more transmission parameters.

In some embodiments, the processor is further configured to receive, from the second device, a control frame that solicits the feedback information, wherein the feedback frame is transmitted in response to the control frame.

In some embodiments, the first frame and the second frame are received in a same transmission opportunity (TXOP) and the feedback frame is transmitted between the first frame and the second frame.

In some embodiments, the feedback frame is a block acknowledgement (BA) variant frame.

In some embodiments, the processor is further configured to receive an initial control frame from the second device to negotiate to provide feedback information; and transmit to the second device, a response frame to the initial control frame that includes an indication that the first device will provide the feedback information.

In some embodiments, the first frame is transmitted on a plurality of channels to check which channels do not suffer from interference, wherein the feedback frame is transmitted on a subset of the plurality of channels that are suitable for transmission.

In some embodiments, the at least one transmission parameter includes at least one of a transmit power, a transmission rate, a bandwidth, a number of spatial streams, or unavailability related information.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates a flow chart of an example process by an AP of advertising a capability message in accordance with an embodiment.

FIG. 5 illustrates an AP advertising a capability to support fast parameter adaptation using beacon frames in accordance with an embodiment.

FIG. 6 illustrates a flow chart of an example process by an STA of advertising support for fast parameter adaptation in accordance with an embodiment.

FIG. 7 illustrates a flow chart of an example process, by a receiver, for feedback for parameter adaptation in accordance with an embodiment.

FIG. 8 illustrates a flow chart of an example process, by a transmitter, for feedback processing for parameter adaptation in accordance with an embodiment.

FIG. 9 illustrates a feedback procedure in accordance with an embodiment.

FIG. 10 illustrates a flow chart of an example process by a transmitter for adapting transmission parameters in accordance with an embodiment.

FIG. 11 illustrates a flow chart of an example process by a receiver for adapting transmission parameters in accordance with an embodiment.

FIG. 12 illustrates parameter adaptation prior to the start of transmission in accordance with an embodiment.

FIG. 13 illustrates an initial control frame (ICF) transmission on different channels in accordance with an embodiment.

FIG. 14 illustrates post transmission feedback in accordance with an embodiment.

FIG. 15 illustrates trigger based post transmission feedback in accordance with an embodiment.

FIG. 16 illustrates a time division policy with unsolicited feedback in accordance with an embodiment.

FIG. 17 illustrates a time division policy with solicited feedback in accordance with an embodiment.

FIG. 18 illustrates a time division policy with indication in accordance with an embodiment.

FIG. 19 illustrates a dedicated channel or RU for reception of transmit side parameter adaptation feedback in accordance with an embodiment.

FIG. 20 illustrates an example negotiation procedure in accordance with an embodiment.

FIG. 21 illustrates an example negotiation procedure in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11bc. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

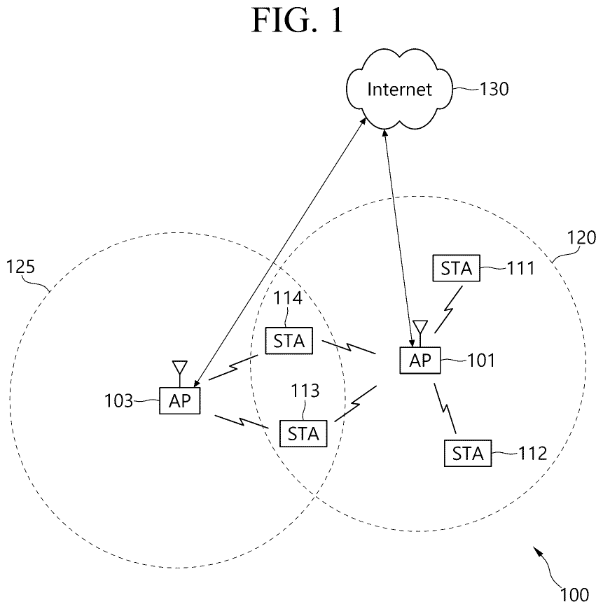

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

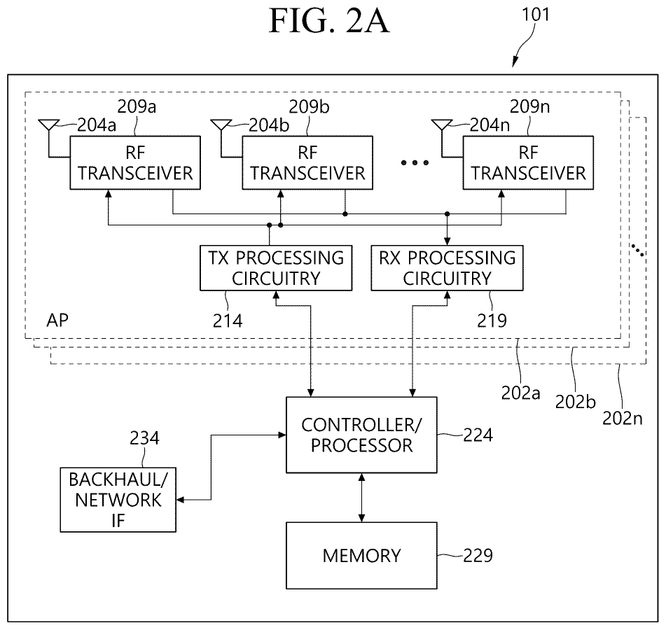

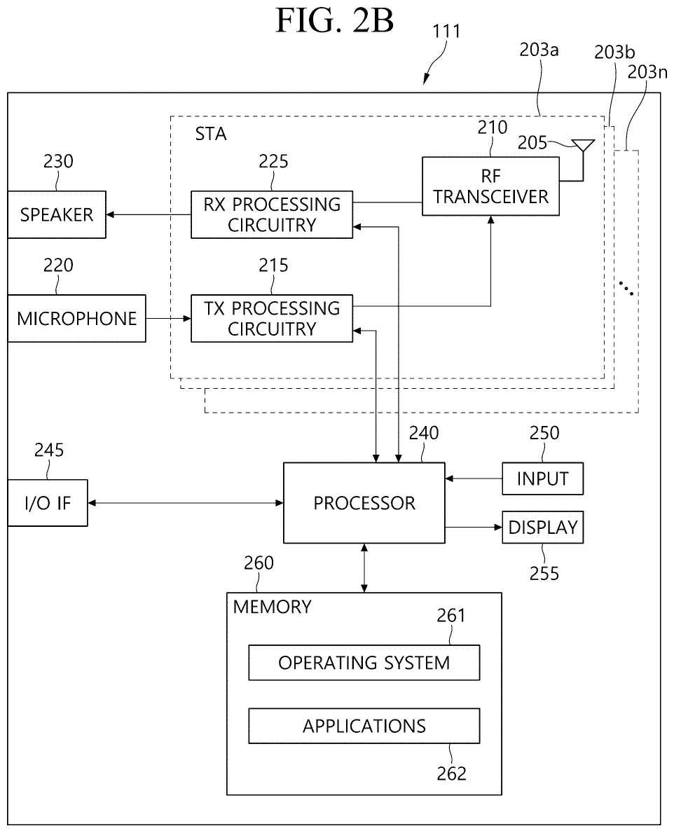

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

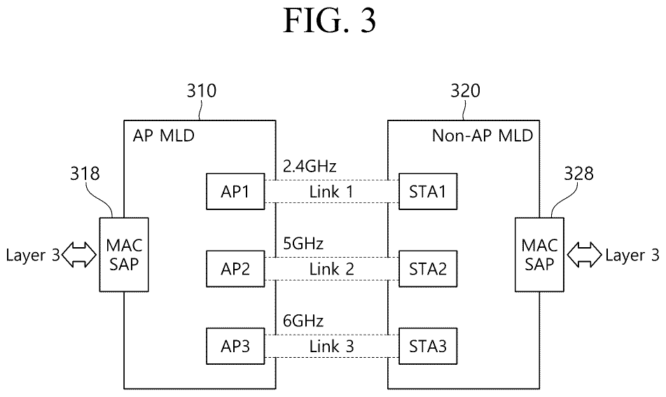

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and ii) IEEE P802.11bc/D5.0, “Wireless LAN Medium Access Control (MAC) and Physical Layer (PHY) Specifications.

In some embodiments, a transmitter in a wireless network may need to set a number of transmit side parameters. These parameters can include but are not limited to: modulation coding scheme (MCS), transmit power, number of spatial streams (NSS), bandwidth (BW), channel, allocated resource unit (RU), guard interval (GI), among others. Further, a scheduler may also need to make decisions on the selection of STAs, start time of transmission to an STA within a transmit opportunity (TXOP), among other decisions. An optimal selection of such parameters can be important to achieve a high throughput and support low latency applications.

With existing techniques, such parameters are adjusted at the transmitter side based on little to no knowledge of the receiver side conditions. This may result in a heuristic derivation of the parameter values at the transmitter side based on a success rate of past transmissions using a particular parameter value. For example, based on the number of successful transmissions seen based on a certain MCS chosen, the transmitter can decide to raise the MCS or to lower it. Techniques that depend on such methodologies for parameter adaptation typically require long convergence times. For example, for rate adaptation, the convergence time can be on the order of several 100s of milliseconds. Until the convergence occurs, the transmitter may operate with suboptimal values that can result in reduced throughput (e.g., if the parameters are chosen very conservatively resulting in larger transmission times) or can result in a hit on latency (e.g., if the parameters are chosen very aggressively resulting in multiple retransmissions). In next generation wireless networks where ultra-low latency traffic support can be considered, the delay tolerance of traffic can be one the order of a few milliseconds. Failure to converge quickly to optimal values can result in additional delays or throughput loss which can be undesirable to such traffic streams. Accordingly, embodiments in accordance with this disclosure enable the fast adaptation of transmit side parameters which help reduce convergence delay times and therefore improve wireless communication, in particular, as required for ultra-low latency traffic.

In some embodiments, a wireless device that can support fast parameter adaptation can advertise the capability to create awareness. If an AP can support fast parameter adaptation technique(s), then the AP can transmit a capability message.

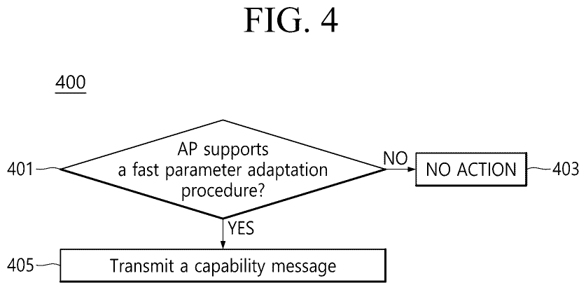

FIG. 4 illustrates a flow chart of an example process by an AP of advertising a capability message in accordance with an embodiment. Although one or more operations are described or shown in particular sequential order, in other embodiments the operations may be rearranged in a different order, which may include performance of multiple operations in at least partially overlapping time periods. The flowchart depicted in FIG. 4 illustrates operations performed in an AP, such as the AP illustrated in FIG. 3.

The process 400, in operation 401, the AP determines whether it supports fast adaptation procedure. If the AP determines that does not support a fast adaptation procedure, the process proceeds to operation 403 and performs no action. If the AP determines that it does support a fast adaptation procedure, the process proceeds to operation 405.

In operation 405, the AP transmits a capability message. In some embodiments, the capability message can include an indication about the support for fast parameter adaptation. Devices that receive this message can understand the AP's support for the fast parameter adaptation and invoke or respond with an appropriate procedure to enable fast parameter adaptation. In some embodiments, the capability message can be in the form of a capability bit or flag that can take a predetermined value (e.g., 1) to show the support for fast parameter adaptation and another predetermined value (e.g., 0) to show otherwise. The capability bit can be transmitted in one or more frames that the AP can transmit (e.g., management frames such as beacons, probe response frames, (Re)association response frames, among others).

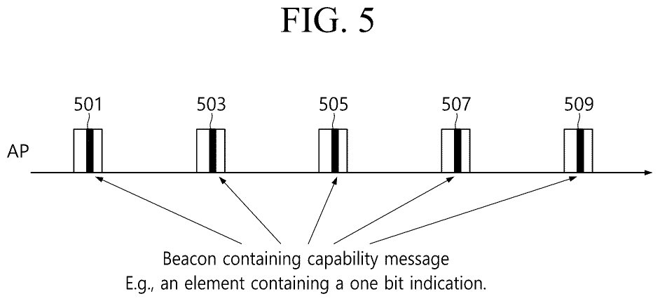

FIG. 5 illustrates an AP advertising a capability to support fast parameter adaptation using beacon frames in accordance with an embodiment. As illustrated, the AP transmits several beacon frames 501, 503, 505, 507 and 509, which include a capability message. For example, the capability message may include a one-bit indication regarding whether the AP supports fast parameter adaptation.

In some embodiments, if an STA can support fast parameter adaptation technique(s), then the STA can transmit capability message.

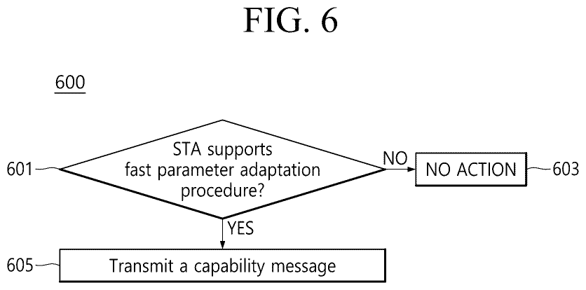

FIG. 6 illustrates a flow chart of an example process by an STA of advertising support for fast parameter adaptation in accordance with an embodiment. Although one or more operations are described or shown in particular sequential order, in other embodiments the operations may be rearranged in a different order, which may include performance of multiple operations in at least partially overlapping time periods. The flowchart depicted in FIG. 6 illustrates operations performed in an STA, such as the STA illustrated in FIG. 3.

The process 600, in operation 601, the STA determines whether it supports fast adaptation procedure. If the STA determines that the STA does not support a fast adaptation procedure, the process proceeds to operation 603 and the STA performs no action. If the STA determines that the STA does support a fast adaptation procedure, the process proceeds to operation 605.

In operation 605, the STA transmits a capability message. In some embodiments, the capability message can include an indication about the STA's support for fast parameter adaptation. Devices that receive the capability message can understand the STA's support for the fast parameter adaptation feature and invoke or respond with an appropriate procedure to enable fast parameter adaptation. In some embodiments, the capability message can be in the form of a capability bit or flag that can take a predetermined value (e.g., 1) to show the support and another predetermined value (e.g., 0) to show otherwise. The capability bit can be transmitted in one or more frames that the STA can transmit (e.g., management frames such as probe request, (Re)association request, among others).

In some embodiments, a transmitter and a receiver can enable a long term feedback procedure for the purpose of parameter adaptation. In some embodiments, the receiver can provide periodic or unsolicited feedback information, which may be included in one or more feedback frames, to the transmitter to assist the transmitter with parameter adaptation. A feedback frame can include at least one or more of the information items as described in Table 1 below.

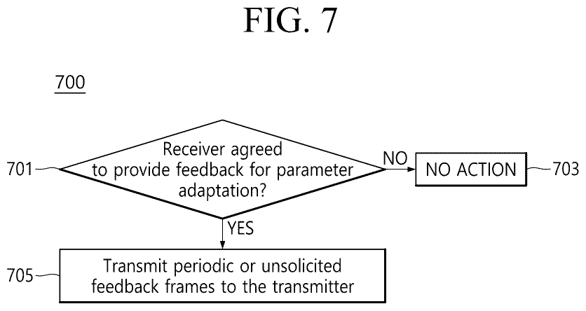

FIG. 7 illustrates a flow chart of an example process, by a receiver, for feedback for parameter adaptation in accordance with an embodiment. Although one or more operations are described or shown in particular sequential order, in other embodiments the operations may be rearranged in a different order, which may include performance of multiple operations in at least partially overlapping time periods. The flowchart depicted in FIG. 7 illustrates operations performed in receiver, such as an STA or an AP illustrated in FIG. 3.

The process 700, in operation 701, the receiver determines whether the receiver has agreed to provide feedback in one or more feedback frames for parameter adaptation. If the receiver determines that the receiver has not agreed to provide feedback for parameter adaptation, the process proceeds to operation 703 and performs no action. If the receiver determines that the receiver has agreed to provide feedback for parameter adaptation, the process proceeds to operation 705.

In operation 705, the receiver transmits periodic or unsolicited feedback frames to the transmitter.

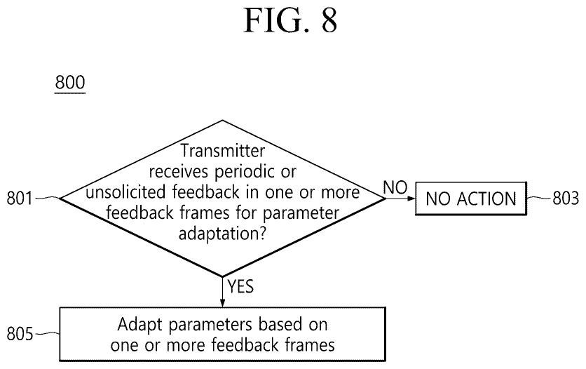

FIG. 8 illustrates a flow chart of an example process, by a transmitter, for feedback processing for parameter adaptation in accordance with an embodiment. Although one or more operations are described or shown in particular sequential order, in other embodiments the operations may be rearranged in a different order, which may include performance of multiple operations in at least partially overlapping time periods. The flowchart depicted in FIG. 8 illustrates operations performed in transmitter, such as an STA or an AP illustrated in FIG. 3.

The process 800, in operation 801, the transmitter determines whether the transmitter receives periodic or unsolicited feedback in one or more feedback frames for parameter adaptation. If the transmitter determines that is has not received period or unsolicited feedback in one of more feedback frames for parameter adaptation, the process proceeds to operation 803 and performs no action. If the transmitter determines that is has received period or unsolicited feedback in one or more feedback frames for parameter adaptation, the process proceeds to operation 805.

In operation 805, the transmitter adapts one or more parameters based on the one or more feedback frames.

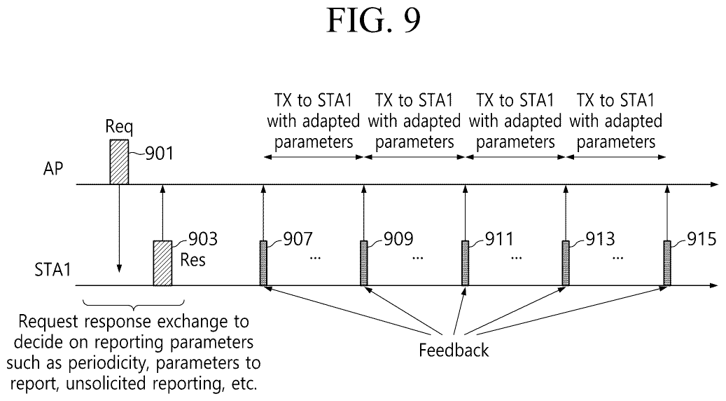

FIG. 9 illustrates a feedback procedure in accordance with an embodiment. In particular, FIG. 9 illustrates communication between an AP and STA1. As illustrated in FIG. 9, the AP and the STA may negotiate various aspects of reporting feedback frames such as periodicity, parameters to report, among other aspects. Upon completion of the negotiation procedure, the STA can report the feedback frames to the AP in a periodic manner. Upon reception of a feedback frame, the AP can adapt the parameters until the next feedback frame is received. In some embodiments, the AP can also adapt parameters after reception of a few feedback frames from the STA instead of adapting after each feedback frame reception. As illustrated in FIG. 9, the AP transmits to STA1 a request frame 901 and STA1 transmits a response frame 903. This request and response exchange may be used to determine reporting parameters, including periodicity, parameters to report, unsolicited reporting, among others. Accordingly, STA1 transmits to AP, feedback frames 907, 909, 911, 913 and 915, whereby after each of these feedback frames, one or more transmission (TX) parameters to STA1 can be reconfigured according to the associated information provided in the respective feedback frame.

In some embodiments there may be a probing procedure to adapt the transmission parameters prior to the start of the transmission. In some embodiments, the probing procedure can involve exchange of initial control messages between the transmitter and the receiver. The transmitter can transmit to a receiver an initial control message to request to setup a feedback procedure with the receiver. In response to the initial control message, the receiver can send to the transmitter a response message to negotiate the feedback procedure, including which transmission parameters to adapt based on the feedback information. The response message can provide the transmitter with information on how to setup the transmit side parameters for the transmission that follows this frame exchange. The content of the response message includes one or more of the information items described in Table 1 below. Based on the response message, the transmitter side can adapt its transmit parameters.

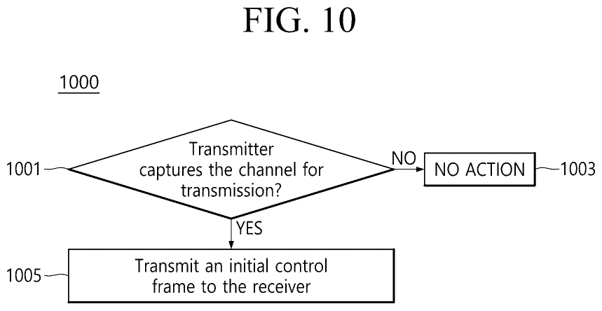

FIG. 10 illustrates a flow chart of an example process by a transmitter for adapting transmission parameters in accordance with an embodiment. Although one or more operations are described or shown in particular sequential order, in other embodiments the operations may be rearranged in a different order, which may include performance of multiple operations in at least partially overlapping time periods. The flowchart depicted in FIG. 10 illustrates operations performed in transmitter, such as an STA or an AP illustrated in FIG. 3.

The process 1000, in operation 1001, the transmitter determines whether the transmitter captures the channel for transmission. If the transmitter determines that it does not capture the channel for transmission, then the process proceeds to operation 1003 and performs no action. If the transmitter determines that it does capture the channel for transmission, then the process proceeds to operation 1005.

In operation 1005, the transmitter transmits an initial control frame to the receiver. The initial control frame may request to setup a feedback procedure with the receiver, including information on one or more transmission parameters that should be provided to the transmitter from the receiver.

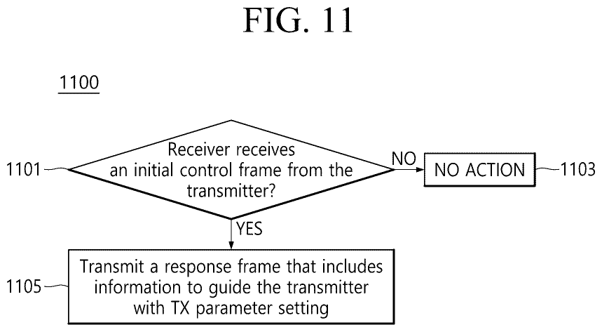

FIG. 11 illustrates a flow chart of an example process by a receiver for adapting transmission parameters in accordance with an embodiment. Although one or more operations are described or shown in particular sequential order, in other embodiments the operations may be rearranged in a different order, which may include performance of multiple operations in at least partially overlapping time periods. The flowchart depicted in FIG. 11 illustrates operations performed in receiver, such as an STA or an AP as illustrated in FIG. 3.

The process 1100, in operation 1101, the receiver determines whether the receiver receives an initial control frame from the transmitter. If the receiver determines that the receiver has not received an initial control frame from the transmitter, the process proceeds to operation 1103 and performs no action. If the receiver determines that the receiver has received an initial control frame from the transmitter, the process proceeds to operation 1105.

In operation 11005, the receiver transmits a response frame that includes information to guide the transmitter with setting the transmission parameters. The response frame can include information on one or more transmission parameters for which feedback information will be provided.

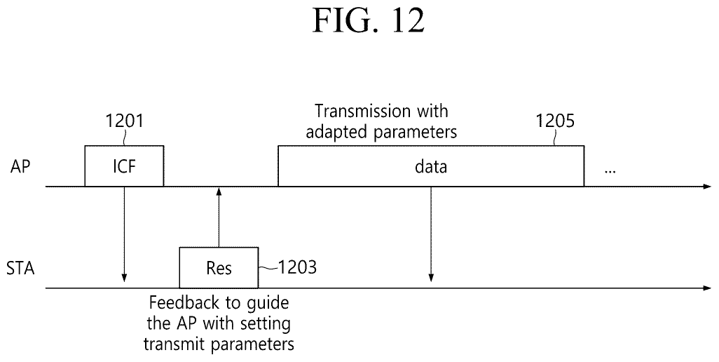

FIG. 12 illustrates parameter adaptation prior to the start of transmission in accordance with an embodiment. In particular, the AP transmits to the STA an initial control frame (ICF) 1201 that requests feedback to guide the AP with setting one or more transmit parameters. In some embodiments, the ICF 1201 can also be transmitted on various channels to check which channel does not suffer from interference. Then, the STA transmits to the AP a response frame 1203 that includes feedback information to guide the AP with setting the one or more transmission parameters. In some embodiments, the response frame 1203 may be transmitted by the receiver on the channels that are suitable for transmission. Based on the information in the response frame 1203, the transmitter adapts the one or more transmission parameters and transmits a data frame 1205 on suitable channels using the adapted transmission parameters.

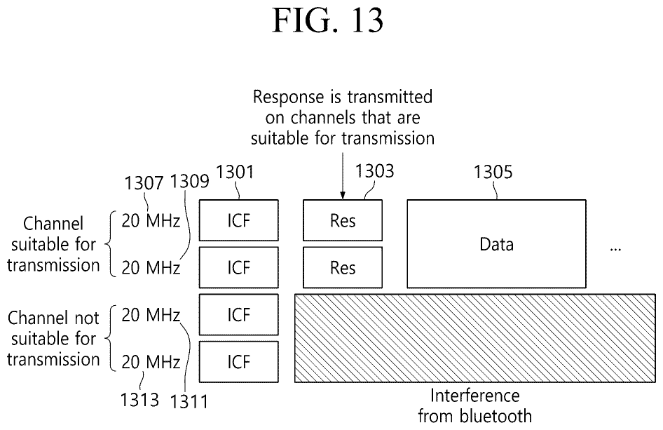

FIG. 13 illustrates an initial control frame (ICF) transmission on different channels in accordance with an embodiment. In particular, the transmitter transmits the ICFs 1301 on several 20 MHz channels, including channels 1307, 1309, 1311, and 1311. In response to the ICFs 1301, the receiver transmits to the transmitter response frames 1303 on channels that are suitable for transmission, including channel 1307 and 1309. As illustrated, channels 1311 and 1313 are experiencing interference from a particular source (e.g., Bluetooth). Accordingly, the transmitter transmits data frame 1305 on channels 1307 and 1309. In some embodiments, the ICF and/or response frame can be a newly defined frame or any of the existing frames in the standard (e.g., a modified RTS, among others).

In some embodiments, the feedback frames can be transmitted by the receiver following the transmission. The transmitter can then use the feedback frame to adapt the transmit side parameters for the next transmission to that particular receiver. In certain embodiments, the transmitter can also perform adaptation after a certain number of transmissions based on the feedback of all those transmissions.

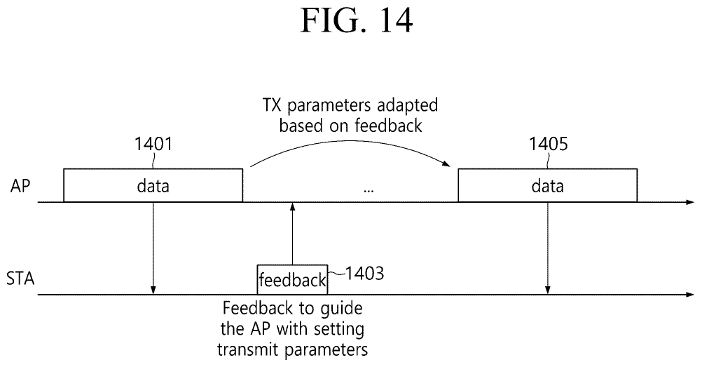

FIG. 14 illustrates post transmission feedback in accordance with an embodiment. As illustrated, the AP transmits to the STA data frame 1401. The STA transmits to the AP feedback frame 1403 to guide the AP with setting the transmit parameters. Accordingly, the AP reconfigures the transmission parameters based on the feedback frame 1403 and transmits to the STA data frame 1405. In some embodiments, the feedback frame 1403 can be a newly defined frame or any of the existing frames in the standard (e.g., a modified BA, among others).

In some embodiments, the feedback frame can be a frame that the transmitter can trigger and request from the receiver.

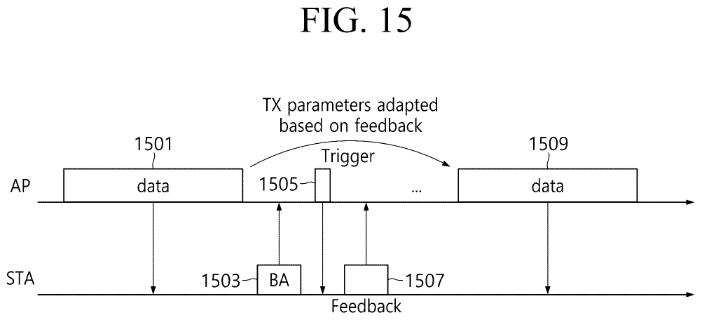

FIG. 15 illustrates trigger-based post transmission feedback in accordance with an embodiment. As illustrated, the AP transmits to the STA a data frame 1501. The STA transmits to the AP a block acknowledgment (BA) frame 1503. The AP transmits to the STA a trigger frame 1505. The trigger frame 1505 may be used to trigger a request for feedback information from the STA. Accordingly, the STA transmits to the AP feedback frame 1507 in response to the trigger frame 1505. Accordingly, the AP adapts the transmission parameters for transmitting data frames to the STA based on the feedback frame 1507. The AP transmits to the STA, data frame 1509 using transmission parameters that have been reconfigured or adapted based on the feedback information including in the feedback frame 1507.

In some embodiments, the adaptation can be done in the same transmission opportunity (TXOP). The adaptation can be performed by adopting a time division policy or a frequency division based policy. In a time division policy, the TXOP can include time durations where the receiver can provide feedback either in a solicited or unsolicited manner.

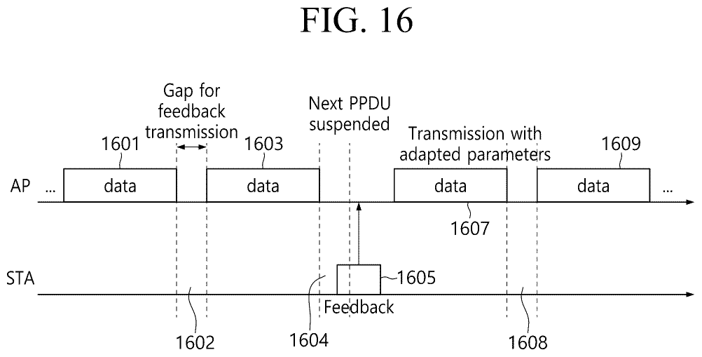

FIG. 16 illustrates a time division policy with unsolicited feedback in accordance with an embodiment. In FIG. 16, the AP leaves a gap between two consecutive PPDU transmissions in the same TXOP. When the STA feels a need for transmit side parameter adaptation, the STA can transmit a feedback frame in the gap before the start of the next PPDU. If the AP receives a feedback frame in the gap, it can suspend the next PPDU and perform transmit parameter adaptation prior to transmitting the next PPDU. In certain embodiments, the AP can also provide an indication in the gap.

Accordingly, as illustrated in FIG. 16, the AP transmits to the STA data frame 1601, which is followed by a gap 1602 where the STA may provide feedback information using one or more feedback frames. After the gap 1602, the AP transmits to the STA another data frame 1603. In the subsequent gap 1604, the STA transmits to the AP a feedback frame 1605, whereby the next PPDU is suspended. The feedback frame 1605 may include information for adapting or reconfiguring at least one transmission parameter. Based on the feedback frame 1605, the AP reconfigures one or more transmission parameters. Accordingly, the AP transmits a data frame 1607 where the transmission is transmitted with parameters that have been reconfigured based on the information in the feedback frame 1605. After another gap 1608, the AP transmits to the STA a data frame 1609.

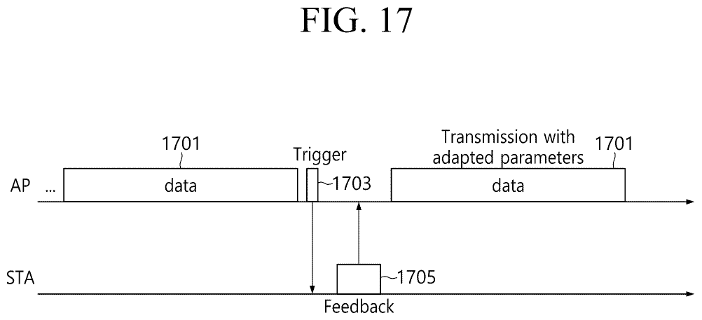

FIG. 17 illustrates a time division policy with solicited feedback in accordance with an embodiment. As illustrated, the AP transmits to the STA a data frame 1701. After transmitting the data frame 1701, the AP transmits to the STA a trigger frame 1703. The trigger frame 1703 may be used to trigger the STA to transmit feedback information regarding one or more transmission parameters in a feedback frame. Accordingly, the STA transmits to the AP a feedback frame 1705 in response to the trigger frame 1703. The feedback frame 1703 may include information to guide the AP in reconfiguring one or more transmission parameters for transmitting data frames to the STA. Accordingly, the AP reconfigures one or more transmission parameters based on the feedback frame 1705 and the AP transmits to the STA a data frame 1707 using the reconfigured transmission parameters.

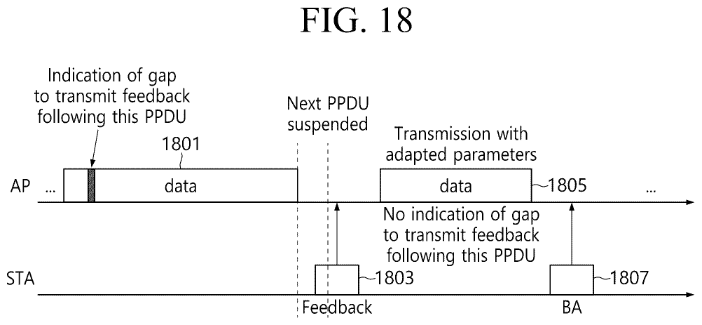

FIG. 18 illustrates a time division policy with indication in accordance with an embodiment. As illustrated, the AP transmits to the STA a data frame 1801 that includes an indication of a gap to transmit feedback information, via a feedback frame, following this data frame 1801 (e.g., PPDU). Accordingly, the STA transmits to the AP a feedback frame 1803 whereby the next data frame transmission is suspended. Accordingly, the AP reconfigures one or more transmission parameters based on the information in the feedback frame 1803. Subsequently, the AP transmits to the STA a data frame 1805 where the transmission is transmitted with the reconfigured parameters based on the feedback frame 1803. Unlike the data frame 1801, the data frame 1805 does not include an indication of a subsequent gap to transmit feedback information following this data frame 1805. Accordingly, the STA transmits to the AP the BA 1807.

In some embodiments, in a frequency division based policy, the receiver can create one dedicated frequency channel or resource unit (RU) for reception of transmit side adaptation parameters.

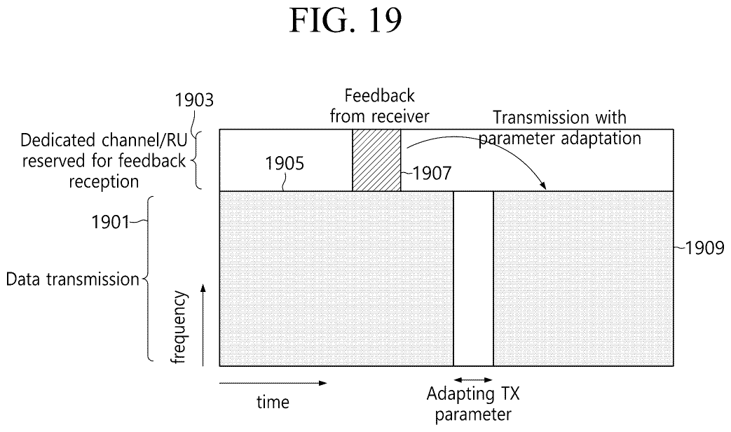

FIG. 19 illustrates a dedicated channel or RU for reception of transmit side parameter adaptation feedback in accordance with an embodiment. In some embodiments, the receiver can be equipped with full duplex capability. As illustrated, data transmission may be within a frequency channel 1901 and there is a dedicated channel or RU 1903 that is reserved for feedback reception. One or more receivers can contend to transmit feedback if the transmitter is transmitting to one or more receivers simultaneously. As illustrated, data frame 1905 is transmitted to a receiver within the data transmission channel 1901 and feedback frame 1907 is received from a receiver within the dedicated channel or RU 1903. Accordingly, the transmitter reconfigures or adapts the transmission parameters based on the feedback frame 1907 and transmits data frame 1909 with the adapted transmission parameters.

In some embodiments, the receiver can provide the transmitter with a number of information items to guide or assist the transmitter with setting the transmit side parameters. These information items provided by the receiver to the transmitter can include one or more of the information items as indicated in Table 1.

TABLE 1

| Information | |
|---|---|
| item | Description |
| Reason | An information item(s) that can describe the reason for a certain event |
| information | occurrence (e.g., reason for unsuccessful transmission) on the receiver |
| | side. e.g., reason code. More examples of reason codes can be as shown |
| | in Table 2. |
| Action | An information item(s) that can describe certain behavior requested on |
| information | the transmitter side by the receiver (e.g., to adapt certain transmit |
| | parameters). e.g., Action code. Alternatively, action can also be requested |
| | via a reason code. |
| Transmit power | An information item(s) that can enable the transmitter to set appropriate |
| setting guidance | transmit power. Examples are shown in Table 4. |
| Received power | An information item(s) that can indicate to the transmitter a received |
| measurement | power measurement at the receiver. Examples can be a shown in Table 5. |
| Interference | An information item that can provide indication on the interference level |
| level indication | at the receiver. e.g., signal to interference and noise ratio (SINR), average |
| | noise plus interference (ANPI), ANIPI, among others. |
| Location | An information item(s) that can inform the transmitter about the location |
| information | of the receiver. This can help the transmitter correlate other information |
| | with location and can be useful to predict an issue's occurrence in the |
| | future. For instance, if STA is in a location and faces interference from a |
| | non-Wi-Fi radio that is not located on the same device, then when STA is |
| | in the same location, it can face interference from the same source. |
| Interference | An information item(s) that can indicate the source of interference at the |
| source | receiver. e.g., if the interference is from on-device non-Wi-Fi radio or a |
| information | non-collocated Wi-Fi/non-Wi-Fi radio. An example signaling can be by |
| | using an encoding to represent each type of interference. Another |
| | example can be by using a bitmap if the types of interferences are limited. |
| Channel | An information item(s) that can provide an indication of the channel |
| measurement | between the transmitter and the receiver. e.g., channel state information |
| information | (CSI). |
| Channel | An information item(s) that can indicate the availability of channel(s) |
| availability | between the transmitter and the receiver. An example can be that of an |
| information | available channel bitmap. The available channel bitmap field can include |
| | a bitmap indicating the subchannels available at the receiver. Each bit in |
| | the bitmap can correspond to a 20 MHz subchannel within the operating |
| | channel width of the BSS, with the LSB corresponding to the lowest |
| | numbered operating subchannel of the BSS. The bit in position X in the |
| | bitmap can be set to 1 to indicate that the subchannel X + 1 is idle; |
| | otherwise, it can be set to 0 to indicate that the subchannel is busy or |
| | unavailable. |
| Antenna | An information item(s) that can indicate the preferred antenna ID at the |
| information | transmitter or the receiver. |
| Collocated | An information item(s) that can indicate the presence of a collocated radio |
| radio presence | that can cause interference to the reception. e.g., a one-bit indicator that |
| indicator | can be set to 1 to make the indication and to 0 to indicate otherwise. |
| | Alternatively, this can be done implicitly by directly reporting collocated |
| | interference information as described below. |
| Collocated | An information item(s) that can characterize interference due to |
| interference | collocated radios. Examples can be as shown in Table 8. |
| information | |
| Predicted/ | An information item(s) that can describe either the collocated radio |
| futuristic | activity in upcoming set period of time. e.g., collocated radio is on and |
| collocated | there is an estimate at the receiver about its activity (if |
| interference | scheduled/periodic/predictable), then the receiver can provide the |
| information | information for it. Example can be as shown in Table 8. |
| Non-collocated | An information item(s) that can characterize interference due to non- |
| interference | collocated radios. Examples are shown in Table 8. |
| information | |
| Transmission | An information item(s) that can indicate the transmission rate that can be |
| rate | used at the transmitter. e.g., MCS rate |
| Transmit power | An information item(s) that can indicate the transmit power that can be |
| | set at the transmitter. |
| Bandwidth | An information item(s) that can indicate the bandwidth at the transmitter |
| | to be used for transmission |
| Number of | An information item(s) that can indicate the number of spatial streams |
| spatial streams | that can be used for transmission. |
| Preferred | An information item(s) that can indicate the preferred resource unit that |
| resource unit | can be used for the next transmission. |
| Scheduled time | An information item(s) that can indicate the time or window at which the |
| | transmission can be carried out to the receiver. e.g., a window of time in |
| | which transmission can be avoided or a window of time in which |
| | transmission can be attempted. |
| Transmit side | An information item(s) that can indicate the parameters at the transmit |
| parameters to | side that can be adapted. e.g., an encoding/bitmap that can indicate which |
| adapt | parameters can be adapted. Transmitter side algorithms can work on |
| | adapting those parameters only. |

The above information items can be transmitted together or separately. They can be transmitted as a part of any existing frame, element, field, or subfield in the standard or can be a part of newly defined ones.

Table 2 provides examples of various events that can be reported via a reason code.

TABLE 2

| Reason | |
|---|---|
| examples | Description |
| Interference due | A reason code can be provided by the receiver to the transmitter to |
| to Co-Existence | indicate that the reason for failure of a reception was due to interference |
| | from a non-Wi-Fi radio on the same device. e.g., Bluetooth radio, UWB |
| | radio, among others. This information can enable the transmitter to take |
| | a number of actions. e.g., defer transmission to the receiver for a set |
| | amount of time. Another example can be that it can indicate to the |
| | transmitter to not drop its MCS to the receiver. In yet another example, |
| | the transmitter can check for such interference on the receiver side (e.g., |
| | via a modified RTS/CTS) prior to next transmission. |
| Interference due | A reason code can be provided by the receiver to the transmitter to |
| to OBSS | indicate that the reason for failure of reception was due to OBSS |
| | interference. |
| Poor signal | A reason code can be provided by the receiver to the transmitter to |
| strength | indicate that the reason for failure was poor receive side signal strength. |
| | This can enable the transmitter to increase its transmit power to this |
| | particular receiver prior to transmission next time. |

Table 3 provides examples of various actions that can be requested via an action code/

TABLE 3

| Action examples | Description |
|---|---|
| Same parameter | Receiver can request the transmitter to maintain the same transmit |
| maintenance | parameters (e.g., data rate or MCS) as before and not to drop the |
| | MCS. e.g., the reception on the receiver side might have failed due to |
| | interference from a non-Wi-Fi radio on the same device and reducing |
| | data rate or MCS may not be necessary. |
| Reducing the | Receiver side may be facing some interference on some portion of the |
| bandwidth for | bandwidth and may want the transmitter to adapt the bandwidth used |
| transmission | to transmit the data to avoid those portions. |
| Defer transmission | Receiver side can request the transmitter to defer its transmission for a |
| | certain period of time. |

Table 4 provides examples on parameters that can provide guidance to set transmit power.

TABLE 4

| Information | |
|---|---|
| item | Description |
| Transmit | The transmit power field can be set to a value of the transmit power used to |
| power field | transmit a frame. It can be less than or equal to the Max Transmit Power |
| | and can indicate the actual power used as measured at the antenna |
| | connector (e.g., in units of dBm) by a transmitter when transmitting a |
| | frame. The actual transmit power can have a tolerance (e.g., ± 5 dB). The |
| | field can be a one octet field including a 2s complement signed integer. |
| | There can also be a Min Transmit Power threshold for the transmit power. |
| Max Transmit | The Max Transmit power field can provide an upper limit (e.g., in units of |
| Power field | dBm), on the transmit power as measured at the antenna connector to be |
| | used by the transmitter on the current channel. The Max Transmit Power |
| | value can have a tolerance (e.g., ± 5 dB). |
| Min Transmit | The Min Transmit power field can provide a lower limit (e.g., in units of |
| Power field | dBm), on the transmit power as measured at the antenna connector to be |
| | used by the transmitter on the current channel. The Min Transmit Power |
| | value can have a tolerance (e.g., ± 5 dB). |

Table 5 provides example parameters that can provide information on received signal power.

TABLE 5

| Information item | Description |
|---|---|
| Received channel | The RCPI field can include an RCPI value, which is an indication of |
| power indicator | the received RF power in the selected channel for a received frame. |
| (RCPI field) | The value of the RCPI field can be a monotonically increasing, |
| | logarithmic function of the received power level. The allowed values |
| | for the RCPI field can be as defined in Table 6, where P is the received |
| | power level in dBm. |
| Received signal- | The RSNI field can include the received signal-to-noise indication for |
| to-noise indicator | the received frame. The value of the RSNI field can be in steps of a |
| (RSNI field) | fixed step size (e.g., 0.5 dB). RSNI can be calculated by the ratio of the |
| | received signal power to the noise plus interference power by using the |
| | expression: |
| | RSNI = (10 × log10((RCPI_{power} − ANPI_{power})/ANPI_{power}) + 10) × 2 |
| | where RCPI_{power} and ANPI_{power} can indicate power domain values for |
| | RCPI and ANPI (average noise power indicator) and not dB domain |
| | values. RSNI in dB can be scaled in steps of 0.5 dB to obtain 8-bit |
| | RSNI values, which can cover the range from −10 dB to +117 dB. The |
| | value 255 can indicate that RSNI is not available. |
| Received Power | The RPI histogram report can include the RPI densities observed in the |
| Indicator (RPI) | channel for a set number of RPI levels. RPI can be a quantized |
| histogram report | measure of the received power level as seen at the antenna connector. |
| | Example levels can be as defined in Table 7. |
| RPI density | Alternatively, if only one density value is measured, then only one |
| | density value can be reported for an entire reception instead of a |
| | histogram. Example of density values and their corresponding |
| | measurement procedure can be as shown in Table 7. |
| Received signal | RSSI parameter as returned in the RXVECTOR. |
| strength indicator | |
| (RSSI) | |

Table 6 provides example of RCPI values.

TABLE 6

| RCPI Value | |
|---|---|
| Description | RCPI Value Description |
| 0 | Represents P < −109.5 dBm |
| 1-219 | Power levels in the range −109.5 ≤ P < 0 are represented |
| | by RCPI = floor(2 × (P + 100)) |
| 220 | Represents P ≥ 0 dBm |
| 221-254 | Reserved |
| 255 | Measurement not available |

Table 7 provides examples of RPI definition for an RPI histogram report.

TABLE 7

| RPI Power observed | RPI Power observed |
|---|---|
| at the antenna | at the antenna |
| connector (dBm) | connector (dBm) |
| 0 | Power ≤ −87 |
| 1 | −87 < Power ≤ −82 |
| 2 | −82 < Power ≤ −77 |
| 3 | −77 < Power ≤ −72 |
| 4 | −72 < Power ≤ −67 |
| 5 | −67 < Power ≤ −62 |
| 6 | −62 < Power ≤ −57 |
| 7 | −57 < Power |

Table 8 provides examples of collocated interference statistics reporting parameters.

TABLE 8

| Information item | Description |
|---|---|
| Interference level | A field that can indicate the maximum level of collocated interference |
| | power (e.g., in units of dBm). The power can be measured over all the |
| | receive chains averaged over a set period of time (e.g., 4us) during an |
| | interference period and across interference bandwidth. If the |
| | interference level is unknown, the field can take a |
| | predetermined/reserved value. |
| Interference | A field that can indicate the expected accuracy of the estimate of |
| accuracy | interference (e.g., in units of dB) with a set confidence interval (e.g., |
| | 95%) |
| Interference type | A field that can take a unique value for each type of interference |
| | source. e.g., Bluetooth, UWB, Wi-Fi, among others. |
| Interference | A field that can indicate the interval between two successive periods |
| interval | of interference (e.g., in microseconds). |
| Interference burst | A field that can indicate the duration of each period of interference |
| length | (e.g., in microseconds) |
| Interference start | A field that can indicate the interference start time of the TSF timer at |
| time | the start of the interference burst. |
| Interference center | A field that can indicate the center frequency of interference (e.g., in |
| frequency | units of 5 kHz). When center frequency is unknown, the STA's |
| | operating channel can be reported. |
| Interference | A field that can indicate the bandwidth (e.g., in units of 5 kHz) as a |
| bandwidth | set roll−off point of the interference signal (e.g., −3 dBm). When the |
| | bandwidth is unknown, the field can take a predetermined/reserved |
| | value. |

In some embodiments, the above parameters can be divided into various categories and the receiver can provide the transmitter with parameters belonging to one or more categories.

Table 9 provides examples of division of parameters.

TABLE 9

| Category | | |
|---|---|---|
| level | Description | Examples |
| 1^{st} level | High level guidance to the AP on reason for | Reason code, action code, |
| | failure of transmission and possible actions | among others. |
| | that can be taken | |
| 2^{nd} level | More detailed feedback which can serve as | Interference levels, Co-ex |
| | an input to AP side algorithm. | presence indication, among |
| | | others. |
| 3^{rd} level | Indication of parameters to adapt | MCS, BW, NSS, among others. |
| 4^{th} level | Value of the parameters to use | Value of the parameters to |
| | | use. Receiver side can |
| | | recommend these values to |
| | | the transmitter side. |
| | | Transmitter side can directly |
| | | use them. |

In some embodiments, a negotiation procedure can be performed to enable the receiver to provide feedback to the transmitter. The parameters that can be negotiated or established during negotiation can be at least one or more of the information items as indicated in Table 10 below.

Table 10 provides examples of parameters that can be negotiated.

TABLE 10

| Information | |
|---|---|
| items | Description |
| Feedback level | An information item that can indicate the feedback level such as the level |
| | that are described in Table 9. |
| Parameters to | An information item that can describe the parameters for which the |
| provide | feedback can be provided. |
| feedback on | |
| Reporting | An information item that can describe the frequency with which the |
| frequency | feedback can be provided. e.g., each TXOP, after every 10 ms, among |
| | others. |

The above information items can be transmitted together or separately. They can be transmitted as a part of any existing frame, element, field, or subfield in the standard or can be a part of newly defined ones.

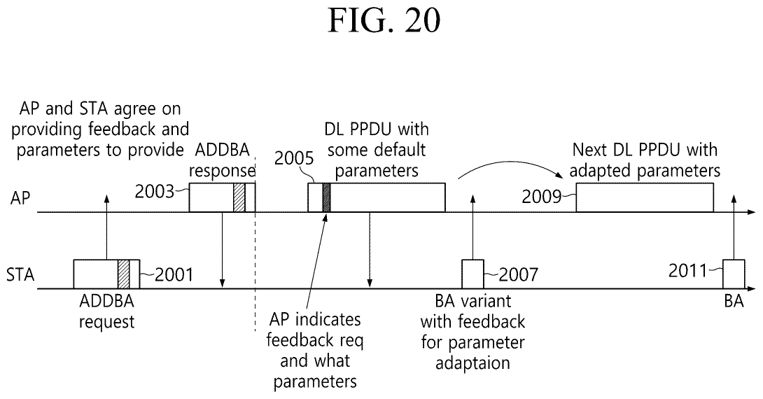

FIG. 20 illustrates an example negotiation procedure in accordance with an embodiment. As illustrated, the negotiation may be done during a block acknowledgement (BA) setup phase and the feedback information is provided via a modified BA. During an add block acknowledgement (ADDBA) phase, the STA can indicate its willingness to assist the AP for one or more traffic streams. For example, if the STA that has an ultra-low latency traffic. The STA can provide feedback immediately after a transmission that requests feedback as well as the parameters on the TX side. In some embodiments, feedback can be provided via a modified BA. The AP can reconfigure the transmission parameters for the next transmission based on the feedback information.

As illustrated in FIG. 20, during the add BA phase (ADDBA), the STA and AP may negotiate a feedback procedure, in particular, the STA transmits to the AP an ADDBA request frame 2001 and in response the AP transmits to the STA and ADDBA response frame, whereby the AP and STA negotiate and/or agree on the STA providing feedback and the particular parameter(s) on which the STA will provide the feedback information. The AP transmits to the STA a data frame 2005, in particular a downlink (DL) PPDU, using a set of default transmission parameters. The data frame 2005 also includes an indication that the AP is requesting feedback information on one or more parameters. In response to the data frame 2005, the STA then transmits to the AP a modified BA frame 2007 that includes feedback information on the one or more parameters. Accordingly, the AP reconfigures the one or more transmission parameters based on the BA frame 2007 and the AP transmits to the STA a data frame 2009 using the reconfigured transmission parameters. The STA then transmits to the AP the BA frame 2011.

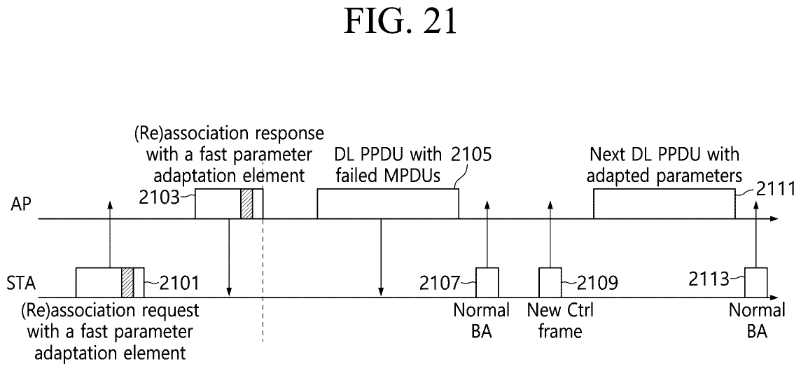

FIG. 21 illustrates an example negotiation procedure in accordance with an embodiment. The negotiation can also occur during (Re)association phase and feedback can be provided via a new control frame that is transmitted immediately following the normal BA. As illustrated, the STA transmits to the AP a (Re)association request frame 2101 that includes a fast parameter adaptation element. The AP transmits to the STA a (Re)association response frame 2101 that includes a fast parameter adaptation element. Accordingly, the AP transmits to the STA a data frame 2105 (e.g., downlink (DL) PPDU with failed MPDUs). The STA transmits to the AP a normal BA frame 2107 and then immediately a control frame 2109, which includes feedback information to guide the AP in reconfiguring one or more transmission parameters. Accordingly, the AP reconfigures one or more transmission parameters based on the control frame 2109 and transmits to the STA a data frame 2111 that is transmitted with the reconfigured parameters. The STA transmits to the AP a normal BA frame 2113. The embodiments described herein may also apply to multi-link operation and to non-managed networks (e.g., P2P, mobile AP, among others).

Embodiments in accordance with this disclosure enable the fast adaptation of transmit side parameters which help reduce convergence delay times and therefor improve wireless communication, in particular, as required for ultra-low latency traffic. In particular, fast adaptation can improve applications that utilize ultra-low latency traffic by quickly converging to optimal values for transmission parameters for transmitting traffic.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first device associated in a wireless network, the first device comprising:
a memory; and
a processor coupled to the memory, the processor configured to:
transmit, to a second device, a first frame using at least one transmission parameter at a first configuration;
receive, from the second device, a feedback frame that includes feedback information related to one or more transmission parameters; and
reconfigure if needed the at least one transmission parameter to a second configuration based on the feedback frame.

2. The first device of claim 1, wherein the first device is a non-access point (AP) station (STA) or an AP STA.

3. The first device of claim 1, wherein the processor is further configured to:
transmit, to the second device, a third frame indicating that the first device is capable of reconfiguring one or more transmission parameters.

4. The first device of claim 1, wherein the processor is further configured to:
receive, from the second device, a feedback frame on a periodic basis that include feedback information related to the one or more transmission parameters.

5. The first device of claim 1, wherein the processor is further configured to:
transmit, to the second device, a control frame that solicits the feedback information, wherein the feedback frame is received in response to the control frame.

6. The first device of claim 1, wherein the first frame and the second frame are transmitted in a same transmission opportunity (TXOP) and the feedback frame is received between the first frame and the second frame.

7. The first device of claim 1, wherein the feedback frame is a block acknowledgement (BA) variant frame.

8. The first device of claim 1, wherein the processor is further configured to:
transmit an initial control frame to the second device to negotiate to receive feedback information; and
receive from the second device, a response frame to the initial control frame that includes an indication that the second device will provide the feedback information.

9. The first device of claim 1, wherein the first frame is transmitted on a plurality of channels to check which channels do not suffer from interference, wherein the feedback frame is received on a subset of the plurality of channels that are suitable for transmission.

10. The first device of claim 1, wherein the at least one transmission parameter includes at least one of a transmit power, a transmission rate, a bandwidth, a number of spatial streams, or unavailability related information.

11. A first device associated in a wireless network, the first device comprising:
a memory; and
a processor coupled to the memory, the processor configured to:
receive, from a second device, a first frame that is transmitted with at least one transmission parameter at a first configuration;
transmit, to the second device, a feedback frame that includes feedback information related to one or more transmission parameters; and
receive, from the second device, a second frame that is transmitted with the at least one transmission parameter at a second configuration.

12. The first device of claim 11, wherein the first device is a non-access point (AP) station (STA) or an AP STA.

13. The first device of claim 11, wherein the processor is further configured to:
receive, from the second device, a third frame indicating that the second device is capable of reconfiguring one or more transmission parameters.

14. The first device of claim 11, wherein the processor is further configured to:
transmit, to the second device, a feedback frame on a periodic basis that include feedback information related to the one or more transmission parameters.

15. The first device of claim 11, wherein the processor is further configured to:
receive, from the second device, a control frame that solicits the feedback information, wherein the feedback frame is transmitted in response to the control frame.

16. The first device of claim 11, wherein the first frame and the second frame are received in a same transmission opportunity (TXOP) and the feedback frame is transmitted between the first frame and the second frame.

17. The first device of claim 11, wherein the feedback frame is a block acknowledgement (BA) variant frame.

18. The first device of claim 11, wherein the processor is further configured to:
receive an initial control frame from the second device to negotiate to provide feedback information; and
transmit to the second device, a response frame to the initial control frame that includes an indication that the first device will provide the feedback information.

19. The first device of claim 11, wherein the first frame is transmitted on a plurality of channels to check which channels do not suffer from interference, wherein the feedback frame is transmitted on a subset of the plurality of channels that are suitable for transmission.

20. The first device of claim 11, wherein the at least one transmission parameter includes at least one of a transmit power, a transmission rate, a bandwidth, a number of spatial streams, or unavailability related information.
